(19) United States
(12) Patent Application Publication
(10) Pub. No.: US 2011/0270458 A1
(43) Pub. Date: Nov. 3, 2011

(54) ELECTRICAL SOCKET APPARATUS WITH OVER-CURRENT PROTECTION

(75) Inventor: YING-CHANG LIU, TAIPEI COUNTY (TW)

(73) Assignee: PRODIGIT ELECTRONICS CO., LTD., TAIPEI COUNTY (TW)

(21) Appl. No.: 12/825,678

(22) Filed: Jun. 29, 2010

(30) Foreign Application Priority Data
Apr. 30, 2010 (TW) 99113979

(51) Int. Cl. G06F 1/28

(52) U.S. Cl. 700/293

(57) ABSTRACT

An electrical socket apparatus with over-current protection is disclosed, including at least two sockets, at least one breaker switch, a current detection unit and a microprocessor. The sockets are coupled in parallel to a power system. The breaker switch is installed in the path of one of the sockets coupled to the power system for breaking or connecting the path of the sockets to the power system. The current detection unit detects the current flowing into the sockets and outputs a set of current values. The microprocessor is coupled to the current detection unit for receiving the set of current values, determining whether a total current flowing into the sockets exceeds a current threshold value and breaking the breaker switch according to a predetermined breaking data when total current flowing into the sockets exceeds the current threshold value.

### FIELD OF THE INVENTION

The invention relates to electrical socket apparatus, and particularly to a electrical socket apparatus with over-current protection.

For the modern buildings, the power lines of the sockets are connected to the commercial alternative current (AC) power system for introducing the AC power to the sockets. The electric equipments receive the power by plugging the plugs in the socket. The sockets and the power lines must meet the electric specifications such as the rated current and the rated voltage, which represent the maximum load current and the maximum load voltage of the power lines. Once the current of the power supply circuit exceeds the rated current, the temperature of the power lines will raise, which results in the material degradation of the sockets and the power lines and even a fire.

For most users, the concepts of safety use of electricity are usually not correct. For example, in order to increase the number of the electric equipments connected to the sockets and expand the ranges of the sockets can be used, users often connect the multi-stages socket or the multi-socket extension cord with the single socket; however, they ignore the total current may exceed the rated current of the sockets and the power lines. In addition, the conventional wall-type sockets often have two or more sockets. These sockets are coupled in parallel to the power system through the same power lines. Users often mistake that the power consumption of each socket can be limited within the rated values by respectively connecting the electric devices with different sockets. In fact, the total current of all sockets may exceed the rated value of the socket apparatus because that the rated current of single socket is the same with the rated current of the socket apparatus.

The fuses and the no fuse breakers (NFBs) will be disconnected from the socket tapped lines of the indoor distribution box (DB) for shutting down power supply when the current flowing through the tapped lines exceeds the rated current; however, users can not know the power usage of the sockets. Furthermore, the fuses and NFBs are disconnected from the socket tapped lines when the current flowing through the tapped lines exceeds the rated current, whereas the lines are in the status of overheating for a period of time. The accumulated heat causes the material degradation of the isolation cladding layer of the lines, and hence the risk of short circuit increase to unacceptable limits.

In light of the previously described problems, an electrical socket apparatus with over-current protection is required.

### SUMMARY OF THE INVENTION

One purpose of the invention is to provide an electrical socket apparatus with over-current protection. For ensuring the socket apparatus against accidents, the socket apparatus detects the current flowing through the sockets by a current detection unit, and microprocessor of the socket apparatus switches off the breaker switches to timely disconnect the socket loops that use electricity excessively when total current of all sockets exceed a current threshold value.

Another purpose of the invention is to provide an electrical socket apparatus with over-current protection. The microprocessor selectively switches off all breaker switches or one of the breaker switches according to the breaking setting data, and thereby substantially enhance the applicability of the socket apparatus.

Another purpose of the invention is to provide an electrical socket apparatus with over-current protection. At least two current detection circuits of the current detection unit respectively detect the current flowing through each socket, and the microprocessor then switches off the corresponding switch breaker when the current flowing through the socket vanished for saving power.

Another purpose of the invention is to provide an electrical socket apparatus with over-current protection. For ensuring the socket apparatus against accidents, at least two temperature detection units of the socket apparatus respectively detect the temperature of each socket, and the microprocessor then switches off the corresponding switch breaker timely when the temperature of the sockets exceed the temperature threshold value.

To achieve said purposes, the invention discloses an electrical socket apparatus with over-current protection, including at least two sockets, at least one breaker switch, a current detection unit and a microprocessor. The sockets are coupled in parallel to a power system. The breaker switch is respectively installed in the path of one of the sockets coupled to the power system for disconnecting or connecting the path of the sockets to the power system. The current detection unit detects the current flowing into the sockets and generates a set of current values. The microprocessor is coupled to the current detection unit for receiving the set of current values, determining whether a total current flowing into the sockets exceeds a current threshold value and switching off the breaker switches or one of the breaker switches according to a breaking setting data when the total current flowing into the sockets exceeds the current threshold value.

In one embodiment, the current detection unit includes at least two current detection circuits respectively installed in the corresponding paths of the sockets coupled to the power system for respectively detecting the current flowing into each of the sockets and thereby generates a set of current values, and the microprocessor receives the set of current values, sums up the set of current values and compares the total current with the current threshold value.

In one embodiment, the electrical socket apparatus with over-current protection further includes at least two temperature detection units for respectively detecting the temperatures of the sockets and outputting temperature values thereof to the microprocessor, and the microprocessor switches off the breaker switches of the corresponding sockets when the temperatures of the sockets exceed a temperature threshold value.

The above summary and the following detail description are used to explain the manners and means that achieve the purposes of the invention, and the effects of the invention. The other purposes and advantages of the invention are illustrated in the following description and drawings.

### BRIEF DESCRIPTION OF THE DRAWINGS

The present invention can be more fully understood by reading the subsequent detailed description and examples with references made to the accompanying drawings which are given by way of illustration only, and thus are not limitation of the present invention, wherein:

FIG. 1 depicts a diagram of a system for an electrical socket apparatus according to first embodiment of the invention;

FIG. 2 depicts a diagram of a system for an electrical socket apparatus according to second embodiment of the invention;

FIG. 3A depicts a diagram of a system for an electrical socket apparatus according to third embodiment of the invention;

FIG. 3B depicts a diagram of a system for an electrical socket apparatus according to fourth embodiment of the invention;

FIG. 4 depicts a diagram of a system for an electrical socket apparatus according to fifth embodiment of the invention; and

FIG. 5 depicts a schematic diagram of an electrical socket apparatus according to the fifth embodiment of the invention.

### DETAILED DESCRIPTION OF THE PREFERRED EMBODIMENTS

The invention provides an electrical socket apparatus with over-current protection, which is characterized by detecting the current flowing into each socket of the socket apparatus. For safety purposes, the electrical socket apparatus breaks the circuitry in time when a total current exceeds the current threshold value.

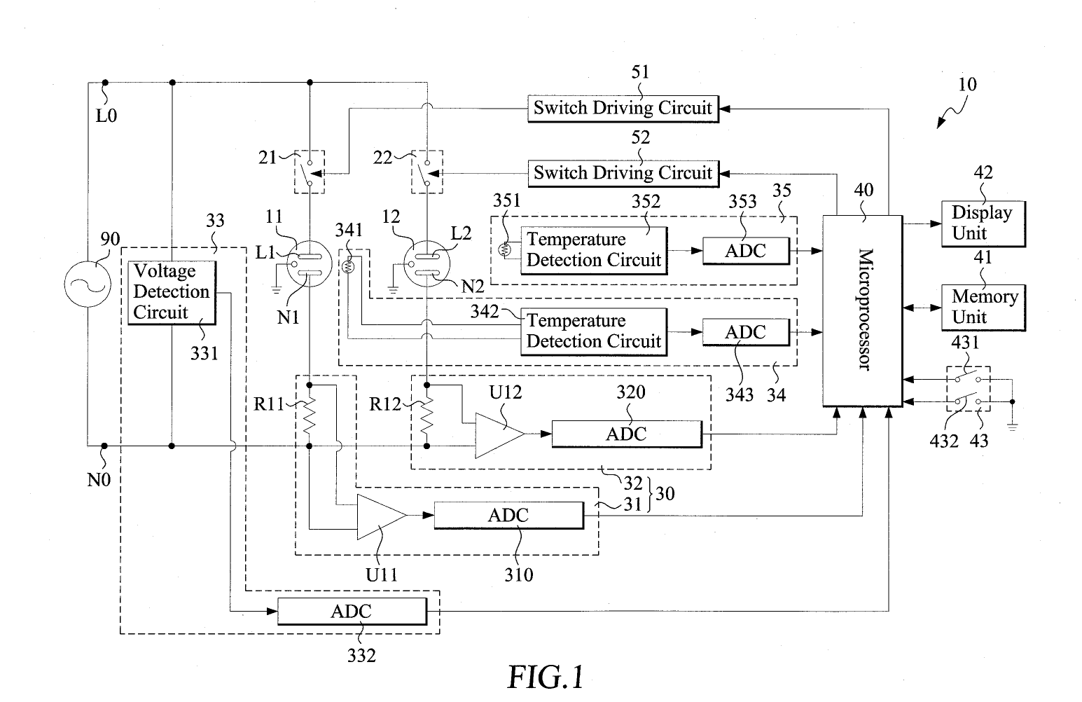

FIG. 1 depicts a diagram of a system for an electrical socket apparatus according to first embodiment of the invention. As shown in FIG. 1, an electrical socket apparatus 10 for over-current protection that is coupled to a power system 90, comprises two sockets 11 and 12, two breaker switches 21 and 22, a current detection unit 30, a voltage detection unit 33, two temperature detection unit 34 and 35, a microprocessor 40, a memory unit 41, a display unit 42, an operation unit 43 and two switch driving circuits 51 and 52.

The power system 90 is connected to a commercial AC power system for supplying AC power to the sockets 11 and 12. The sockets 11 and 12 are coupled in parallel to the power system 90 for receiving the plug-in of the external loads and forming a power supply circuit. In particular, the power lines connecting to the power system 90 includes a line wire and a neutral wire. The line wire terminals L1 and L2 of the sockets 11 and 12 are coupled to the line wire terminal L0 of the electrical socket apparatus 10, and the neutral wire terminals N1 and N2 of the sockets 11 and 12 are coupled to the neutral wire terminal N0 of the electrical socket apparatus 10.

The microprocessor 40 controls the electrical socket apparatus 10. The microprocessor 40 controls the peripheral units and performs data processing according to the predetermined firmware for achieving the predetermined functions of the sockets apparatus 10. The memory unit 41 is a memory for storing the firmware and the setting values. The display unit 42 includes a signal indicator consisting of one or more lightening device(s). The display unit 42 shows the status of the electrical socket apparatus 10 according to the signal indicator and displays the operation information of the electrical socket apparatus 10 by a screen display consisting of one or more panels. The operation unit 43 is an input interface consisting of bottoms and switches. The operation unit 43 receives various inputs of external operations (such as various parameters and setting data) and outputs operation signals to the microprocessor 40 according to the inputs for controlling the operations of the electrical socket apparatus 10.

The breaker switches 21 and 22 are relays, which are installed in the path between the line wire terminals L1 and L2 and the terminals coupled to the power system 90 for breaking (opening/switching off) or connecting (closing/switching on) the path of the sockets to the power system according to control signals of the microprocessor 40. The switch driving circuits 51 and 52 are respectively coupled between the microprocessor 40 and the breaker switches 21 and 22 for amplifying the control signals of the microprocessor 40 such that the breaker switches 21 and 22 can switch the status thereof.

The current detection unit 30 detects the current flowing into the sockets 11 and 12 and outputs a set of current values to the microprocessor 40. The memory unit 41 stores a current threshold value and breaking setting data, in which the current threshold value is the maximum current value output from the electrical socket apparatus 10 and can be set according to the rated current of the electrical socket apparatus 10. When the current flowing into the electrical socket apparatus 10 exceeds the current threshold value, the electrical socket apparatus can interrupt the power output from the socket 11 and 12 or one of the socket 11 and 12. In this manner, the electrical socket apparatus 10 can prevent the fire hazard caused by over current.

The microprocessor 40 receives the set of current values for determining whether the total current flowing into the sockets exceeds the current threshold value and selectively breaking the breaker switches 21 and 22 or one of the breaker switches 21 and 22 according to the breaking setting data when the total current flowing into the sockets 11 and 12 exceeds the current threshold value. For safety purposes, the electrical socket apparatus 10 breaks the circuitry in time when the total current exceeds the current threshold value.

The operation unit 43 includes two manual switches 431 and 432, which are coupled to the microprocessor 40 for receiving external operations, providing the operation signals to the microprocessor 40 and thereby controlling the microprocessor 40 to switch on or off the breaker switches 21 and/or 22. In one embodiment, the manual switches 431 and 432 have two functions but is not limited thereto. One is to switch on and off the breaker switches 21 and/or 22 by the manual switches 431 and 432. When electric equipments do not need to use the power system 90, the manual switches 431 and 432 are enabled to switch off the breaker switches 21 and/or 22 for stopping the power supply of the sockets 11 and 12 instead of removing the plug; and the manual switches 431 and 432 are enabled again to switch on the breaker switches 21 and/or 22 for restoring the power supply of the sockets 11 and 12. Another is as a reset device for the electrical socket apparatus 10. When the microprocessor 40 detects power anomalies, the breaker switches 21 and 22 are switched off according to the control signals of the microprocessor 40. After performing the troubleshooting (such as turning off electric equipments for lowering the power consumption), the manual switches 431 and 432 are enabled again such that the microprocessor 40 outputs the control signals to the switch driving circuits 51 and 52, and the switch driving circuits 51 and 52 receive and amplify the control signals such that the breaker switches 21 and/or 22 become(s) a connecting state from a disconnecting state for recovering the power supply of the sockets 11 and 12.

In the embodiment, the current detection unit 30 includes two current detection circuits 31 and 32, which are respectively installed between the neutral wire terminals N1 and N2 of the sockets 11 and 12 and the nodes coupled to the power system 90 for respectively detecting the current flowing into each of the sockets 11 and 12. The current detection circuit 31 includes a resistor R11, an operational amplifier (OP AMP) U11 and an analog-to-digital converter (ADC) 310. The resistor R11 is installed in the path between the socket 11 and the OP AMP U11. When current flow through the socket 11, the voltage difference is formed between two terminals of the resistor R11, and two input terminals of the OP AMP U11 are coupled to two terminals of the resistor R11 for receiving the voltage difference and amplifying the voltage difference. The ADC 310 converts the amplified voltage difference into a first current value and outputs the first current value to the microprocessor 40. Similarly, the current detection circuit 32 includes a resistor R12, an OP AMP U12 and an ADC 320. The resistor R12 is installed in the path between the socket 12 and the OP AMP U12. When current flow through the socket 12, the OP AMP U12 amplifies the voltage difference between two terminals of the resistor R12, and the ADC 320 converts the amplified voltage difference into a second current value and outputs the second current value to the microprocessor 40.

The set of current values output from the current detection unit 30 includes the first current value and the second current value, which represent the current flowing into the sockets 11 and 12, respectively. The microprocessor 40 receives and sums up the first current value and the second current value, and compares the total current with the current threshold value for controlling the beaker switches 21 and/or 22. When the current flowing into the sockets 11 and/or 12 are(is) weak enough such that the first and/or second current value(s) detected by the microprocessor 40 become(s) zero and the breaker switches 21 and 22 are in the switching-on status, the microprocessor 40 further breaks the corresponding breaker switch(es) 21 and/or 22 for saving the power consumption.

The voltage detection unit 33 includes a voltage detection circuit 331 and an ADC 332, in which the voltage detection circuit 331 is coupled between the line wire and the neutral wire of the electrical socket apparatus 10 for detecting a loop voltage resulted from sockets 11 and 12 being coupled to the power system 90. The loop voltage is divided by the resistors and then output to the ADC 332. The ADC 332 converts the divided loop voltage into a digital voltage value and then outputs the voltage value to the microprocessor 40. Besides, the memory unit 41 stores a voltage range, including an upper voltage threshold value and a lower voltage threshold value. When the microprocessor 40 detects the voltage value out of the voltage range, the microprocessor 40 generates the control signals to control the switch driving circuits 51 and 52 to switch off the breaker switches 21 and 22 for ensuring the electrical socket apparatus against accidents.

The temperature detection unit 34 includes a temperature sensing element 341, a temperature sensing circuit 342 and an ADC 343. The temperature sensing element 341 is a thermal resistor, which is installed around the socket 11 for detecting the temperature thereof and generating temperature detection signals. The temperature sensing circuit 342 receives and amplifies the temperature detection signals, and then outputs the amplified temperature detection signals to the ADC 343. The ADC 343 receives and converts the amplified temperature detection signals into digital temperature detection values, and outputs the digital temperature detection values to the microprocessor 40. The memory unit 41 also stores a temperature threshold value. When the temperature values exceed the temperature threshold value, the microprocessor 40 outputs the control signals to switch off the breaker switches 21. Similarly, the temperature detection unit 35 includes a temperature sensing element 351, a temperature sensing circuit 352 and an ADC 353 for detecting the temperature of the socket 12 and hence outputting digital temperature detection values to the microprocessor 40. When the temperature values exceed the temperature threshold value, the microprocessor 40 outputs the control signals to switch off the breaker switches 22. Accordingly, the electrical socket apparatus 10 can be prevented from being overheated. In addition, the temperature detection unit 34 and 35 can be installed by a temperature detection chip including a temperature element and a signal-processing circuit.

In addition, the microprocessor 40 combines the current values, the temperature detection values and the voltage values for forming screen information. The microprocessor 40 controls the display unit 42 for displaying the screen information, which allows the users to know the parameters of the electrical socket apparatus 10.

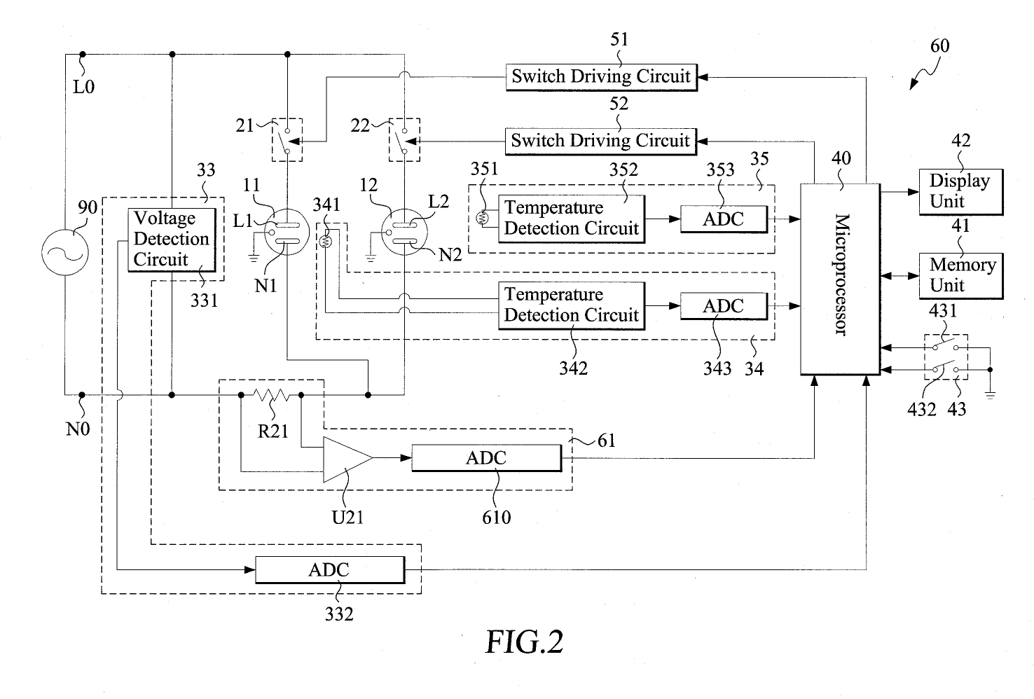

FIG. 2 depicts a diagram of an electrical socket apparatus according to second embodiment of the invention. As shown in FIG. 2, the difference between the first embodiment and the second embodiment is that the current detection unit 61 of the electrical socket apparatus 60 only includes one current detection circuit, which the current detection circuit includes a resistor R21, an OP U21 and an ADC 610. The resistor R21 is installed in the path between the power system 90 and the sockets 11 and 12, which the sockets 11 and 12 are coupled in parallel. When the total current flows through the socket 11 and 12, the voltage difference is formed between two terminals of the resistor R21, and two input terminals of the OP U21 are coupled to two terminals of the resistor R21 for receiving the voltage difference and amplifying the voltage difference. The ADC 610 receives and converts the amplified voltage difference into digital current values, and outputs the digital current values to the microprocessor 40. The microprocessor 40 controls the switch driving circuit 51 and/or 52 to switch on/off the breaker switch(es) 21 and/or 22 according to the current values obtaining from the total current of the sockets 11 and 12.

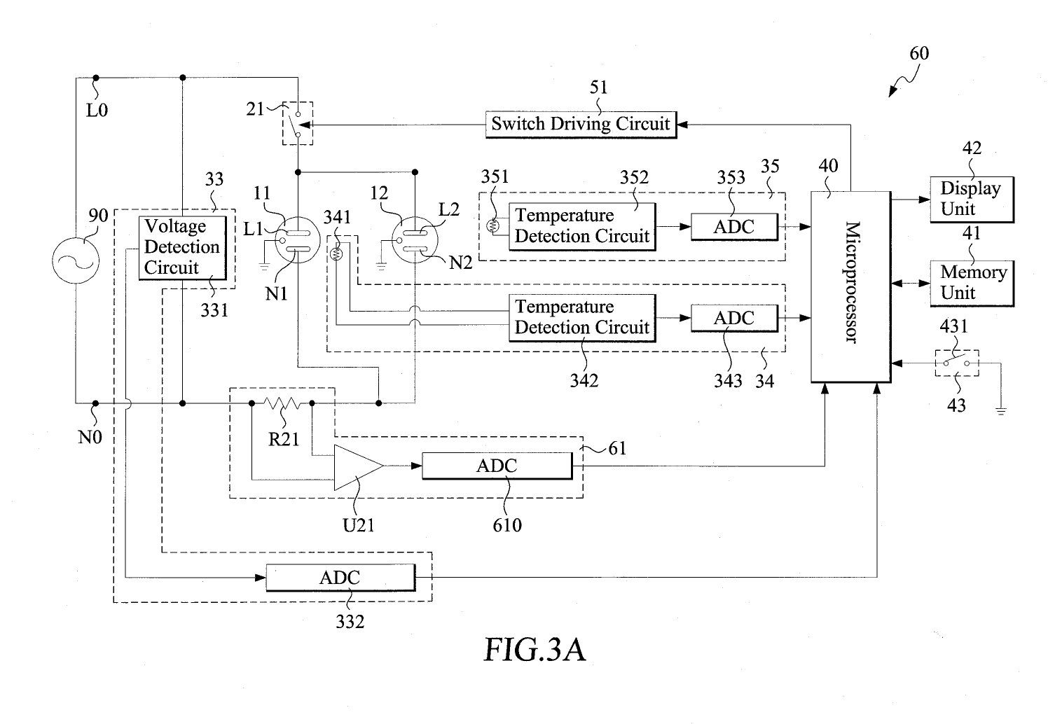

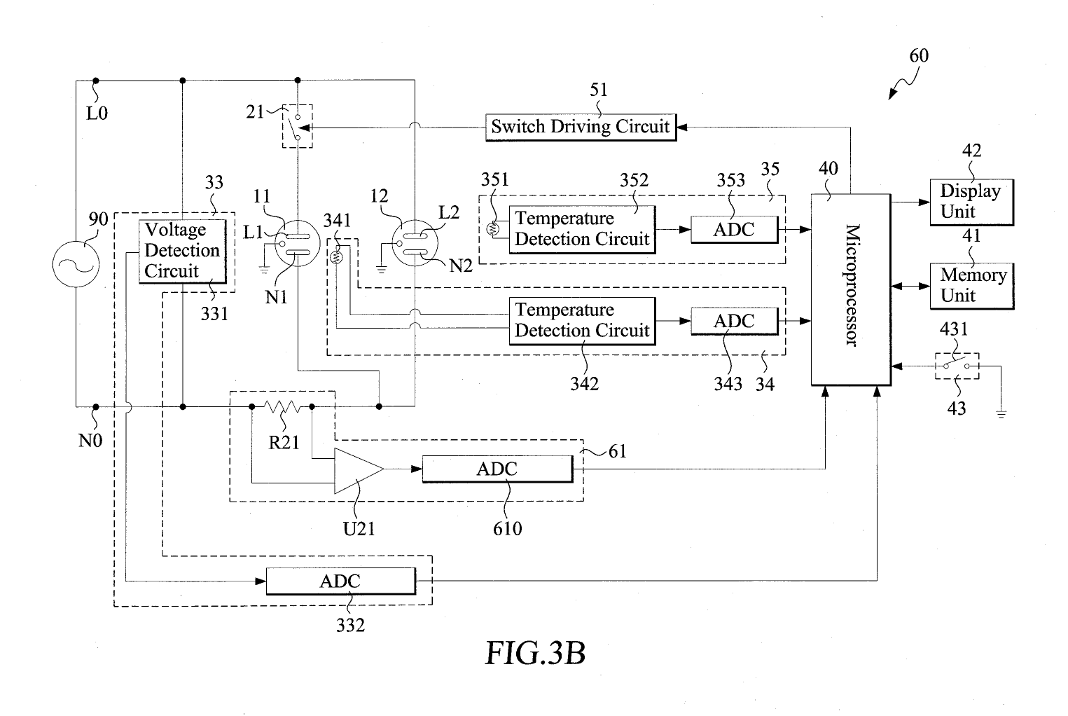

FIG. 3A depicts a diagram of an electrical socket apparatus according to third embodiment of the invention. The third embodiment is substantially similar to the second embodiment; however, only one breaker switch 21 is installed in the electrical socket apparatus 60. The breaker switch 21 is coupled between the power system 90 and the sockets 11 and 12, in which the sockets 11 and 12 are coupled in parallel. The microprocessor 40 generates the control signals to control the switch driving circuit 51 to switch on/off the breaker switches 21, and hence the power system 90 can either provide power to the sockets 11 and 12 simultaneously or not.

FIG. 3B depicts a diagram of an electrical socket apparatus according to fourth embodiment of the invention. The fourth embodiment is substantially similar to the third embodiment. As shown in FIG. 3B, the difference between the third embodiment and the fourth embodiment is that the electrical socket apparatus 60 only includes one breaker switch 21. The breaker switch 21 is coupled between the power system 90 and the socket 11. It is noted that the socket 12 is directly coupled to the power system 90. The microprocessor 40 generates the control signals to control the switch driving circuit 51 to switch on/off the breaker switches 21, and hence the power system 90 can either provide power to the socket 11 or not.

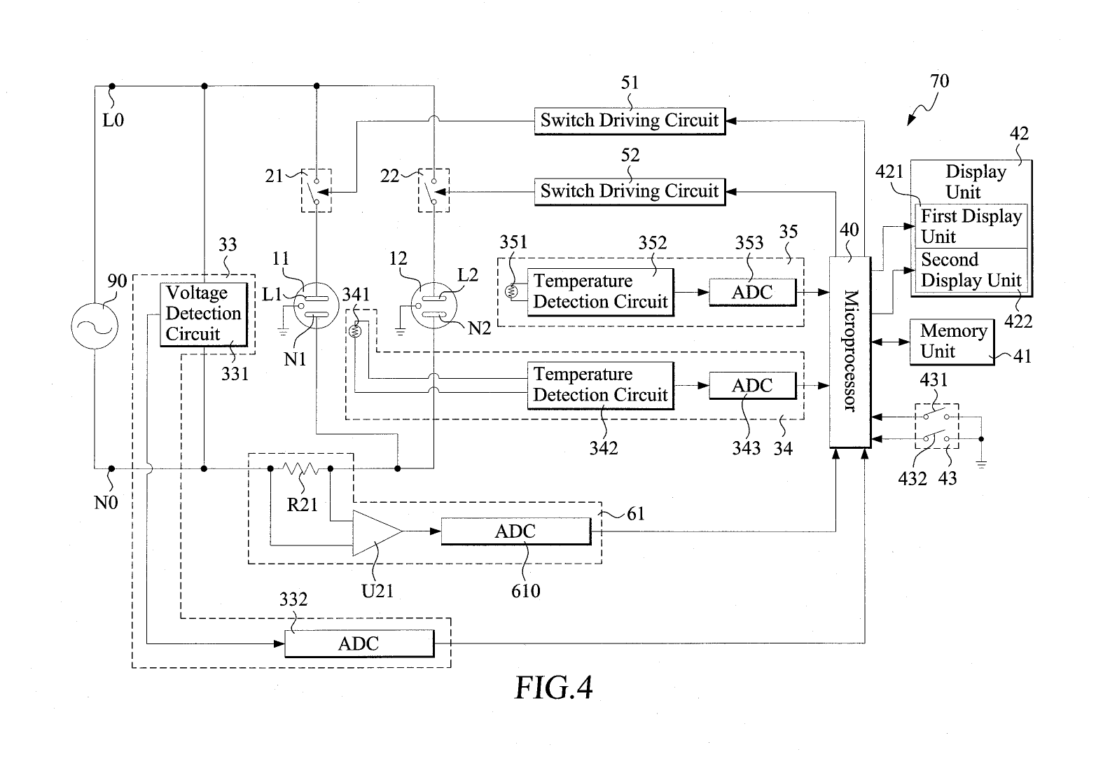

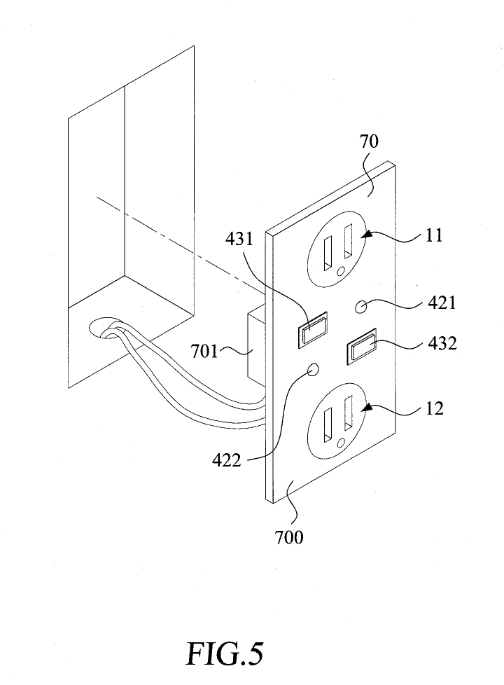

FIG. 4 depicts a diagram of an electrical socket apparatus according to fifth embodiment of the invention. FIG. 5 depicts a schematic diagram of an electrical socket apparatus according to the fifth embodiment of the invention. As shown in FIG. 4, the display unit 42 of the electrical socket apparatus 70 includes a first display 421 and a second display 422, which are coupled to the microprocessor 40 for respectively displaying the status of power supply of the sockets 11 and 12, such as the status of normal power supply, stopping power supply, over-current protection, over-voltage protection, low-voltage protection or abnormal temperature protection. In FIG. 5, the first display 421 and the second display 422 are illustrated with the light emitting devices, which display the status of the respective sockets by the light colors or flickering frequencies. In other embodiment, the statuses of the sockets are displayed by the text or drawings shown in a display panel.

In FIG. 5, the electrical socket apparatus 70 is fabricated as a wall-type electrical socket apparatus, which is coupled to the power system through the power lines. The electrical socket apparatus 70 includes a casing 700 having the plug holes of the sockets 11 and 12 thereon, the manual switches 431 and 432, the first and the second displays 421 and 422 and a storage cavity 701 for storing the electric devices and circuit boards of the electrical socket apparatus 70. In other embodiment, the electrical socket apparatus with over-current protection is fabricated as an extension-type socket.

Note that the electrical socket apparatus disclosed herein includes two or more sockets. Practically, the number of the sockets is selected arbitrarily, and with the number of the sockets to design the control mechanism of the breaker switches, the current detection unit, the temperature detection unit and the microprocessor. The electrical socket apparatus herein are illustrated with two sockets but is not limited thereto. In foregoing embodiments, the breaker switches 21 and/or 22 can be installed in the loops of the sockets 11 and 12, respectively; or in one loop of the sockets 11 or 12.

The electrical socket apparatus with over-current protection disclosed herein detect the current flowing through the sockets, and selectively break all breaker switches or any breaker switch according to the breaking setting data. The socket loops that use electricity excessively can be disconnected timely for ensuring the electrical socket apparatus against accidents. The socket can be arbitrary selected with demands to stop outputting power, and thereby substantially enhance the applicability of the electrical socket apparatus. According to one embodiment, the current detection units detect the current of each socket, and the microprocessor then switches off the corresponding switch breaker when the current flowing through the socket vanished for saving power. In addition, the electrical socket apparatus further includes a temperature detection unit and a voltage detection unit for detecting the temperature and the loop voltages of the sockets for ensuring the electrical socket apparatus against accidents.

When the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electrical socket apparatus, comprising:
at least two sockets coupled in parallel to a power system;
at least one breaker switch installed in a path of one of the sockets coupled to the power system for disconnecting or connecting the path of the sockets to the power system;
at least one current detection unit for detecting a current flowing into the sockets and generating a current value; and
a microprocessor coupled to the current detection unit for receiving the current value, determining whether a total current flowing into the sockets exceeds a current threshold value and switching off the breaker switch according to a breaking setting data when the total current flowing into the sockets exceeds the current threshold value.

2. The electrical socket apparatus as claimed in claim 1, wherein the current detection unit comprises a current detection circuit installed in the path of the sockets coupled in parallel to the power system for detecting the current flowing into the sockets and thereby generates the current value.

3. The electrical socket apparatus as claimed in claim 1, wherein the current detection unit comprises at least two current detection circuits respectively installed in the corresponding paths of the sockets coupled to the power system for respectively detecting the current flowing into each of the sockets and thereby generates a set of current values, and the microprocessor receives the set of current values being the sum of the current values and compares the total current with the current threshold value.

4. The electrical socket apparatus as claimed in claim 3, wherein after the microprocessor receives the current values, the microprocessor further switches off the breaker switches of the corresponding sockets when one of the current values vanished.

5. The electrical socket apparatus as claimed in claim 1, further comprising at least two temperature detection units for respectively detecting the temperatures of the sockets and outputting temperature values thereof to the microprocessor, and the microprocessor switches off the breaker switches of the corresponding sockets when the temperature values of the sockets exceed a temperature threshold value.

6. The electrical socket apparatus as claimed in claim 1, further comprising at least two manual switches coupled to the microprocessor for receiving external operations and controlling the microprocessor to switch on or off the breaker switches.

7. The electrical socket apparatus as claimed in claim 1, further comprising a voltage detection unit for detecting a terminal voltage of the socket coupled to the power system and outputting a voltage value to the microprocessor, and the microprocessor switches off each of the breaker switches when the voltage value exceeds a voltage range, wherein the voltage range comprises an upper voltage threshold value and a lower voltage threshold value.

8. The electrical socket apparatus as claimed in claim 1, further comprising at least one display unit coupled to the microprocessor for performing displaying operations according to the control of the microprocessor.

9. The electrical socket apparatus as claimed in claim 8, wherein the display unit is selected from the group consisting of a signal indicator, a display panel and combinations thereof.

10. The electrical socket apparatus as claimed in claim 1, wherein the socket is selected from the group consisting of a wall-type socket apparatus and an extension-type socket apparatus.
